(19) United States
(12) Patent Application Publication
(10) Pub. No.: US 2025/0391371 A1
(43) Pub. Date: Dec. 25, 2025

(54) DISPLAY DEVICE AND METHOD OF DRIVING THE SAME

(71) Applicant: Samsung Electronics Co., Ltd., Suwon-si (KR)

(72) Inventors: Byong-Deok CHOI, Seoul (KR); Yong-Duck KIM, Seoul (KR); Hyeon-Jun SHIN, Seoul (KR); Jun-Hwan JANG, Seoul (KR)

(73) Assignees: Samsung Electronics Co., Ltd., Suwon-si (KR); IUCF-HYU (Industry-University Cooperation Foundation Hanyang University), Seoul (KR)

(21) Appl. No.: 19/242,262

(22) Filed: Jun. 18, 2025

(30) Foreign Application Priority Data
Jun. 19, 2024 (KR) 10-2024-0079734

(51) Int. Cl. G09G 3/3241; G09G 3/00; G09G 3/3275

(52) U.S. Cl. CPC G09G 3/3241; G09G 3/006; G09G 3/3275; G09G 2300/0819; G09G 2300/0852; G09G 2300/0861; G09G 2310/027; G09G 2320/0233; G09G 2320/045; G09G 2330/021; G09G 2330/028

(57) ABSTRACT

A display device includes a display panel including a plurality of pixels connected to a plurality of data lines and a plurality of return lines; a timing controller that generates a first image data corresponding to a first selection pixel connected to a first data line among the plurality of data lines and a first return line among the plurality of return lines; and a data driver that applies a first data signal corresponding to a measurement reference voltage to the first selection pixel through the first data line, measures a characteristic of the first selection pixel based on a first return signal received through the first return line, and generates a second data signal corresponding to the first image data based on the characteristic of the first selection pixel.

### CROSS-REFERENCE TO RELATED APPLICATION

This application claims priority to and the benefit of Korean Patent Application No. 10-2024-0079734 filed in the Korean Intellectual Property Office on Jun. 19, 2024, the entire contents of which are incorporated herein by reference.

### BACKGROUND

The present disclosure relates to display devices and driving methods of display devices.

With the advancement of an information communication technology, information related to various types of images is being distributed. As an amount of data processed to provide the image information increases, higher-performance display devices are becoming increasingly desirous and advantageous. For example, display devices using organic light-emitting diodes (OLEDs), which have a self-light-emitting characteristic, are being researched and developed. Display devices using an organic light-emitting diode may include a plurality of pixels including one organic light-emitting diode and one transistor. However, the characteristics of each transistor in the plurality of pixels may be different. Accordingly, even if a voltage corresponding to the same data is applied, the currents flowing through the pixels may be different, resulting in a problem of deteriorating a luminance uniformity of the display device.

To improve the quality of the images displayed by display device, a display driver integrated circuit (DDI) for displaying the images on a display panel may perform various operations.

### SUMMARY

The present disclosure provides a display device with more uniform luminance and a driving method of the display device.

Some example embodiments of the present disclosure provide a display device that includes a display panel including a plurality of pixels connected to a plurality of data lines and a plurality of return lines; a timing controller that generates first image data corresponding to a first selection pixel connected to a first data line among the plurality of data lines and a first return line among the plurality of return lines; and a data driver that applies a first data signal corresponding to a measurement reference voltage to the first selection pixel through the first data line, measures a characteristic of the first selection pixel based on a first return signal received through the first return line, and generates a second data signal corresponding to the first image data based on the characteristic of the first selection pixel.

An operation method of a display device according to some example embodiments includes determining a first pixel among a plurality of pixels connected to a plurality of data lines and a plurality of return lines as a selection pixel; applying a first data signal corresponding to a desired (and/or alternatively predetermined) measurement reference voltage to the selection pixel through a first data line connected to the selection pixel among the plurality of data lines; measuring a first output current received through a first return line connected to the selection pixel among the plurality of return lines; obtaining a first equation by performing a partial differentiation on the first output current with respect to the first data signal; obtaining a second equation by performing an indefinite integration on the first equation with respect to the first data signal; measuring a first pixel current output from the selection pixel in response to the first data signal being applied to the selection pixel based on the second equation; and obtaining a pixel characteristic data indicating a characteristic of the selection pixel based on the first pixel current.

A display device according to some example embodiments includes a display panel including a plurality of pixels connected to a plurality of data lines and a plurality of return lines; a timing controller that generates a first image data, stores a pixel characteristic data of indicating a value of a first pixel current output from the first selection pixel in response to a first data signal being applied to a first selection pixel among the plurality of pixels, and stores an ideal data indicating an ideal co-relationship between the first data signal and the first pixel current; and a data driver that generates a first gamma voltage corresponding to the first image data, determines a compensation voltage based on the ideal data and the pixel characteristic data, and generates a second data signal corresponding to the first image data by adding the first gamma voltage and the compensation voltage.

### BRIEF DESCRIPTION OF THE DRAWINGS

FIG. 1 is a block diagram showing a display system according to some example embodiments.

FIG. 2 is a block diagram showing a display device according to some example embodiments.

FIG. 3 is a block diagram showing a configuration of a data driver according to some example embodiments.

FIG. 4 is a circuit diagram of a pixel according to some example embodiments.

FIG. 5 is a view showing a current flowing through selection pixels and non-selection pixels according to FIG. 4.

FIG. 6 is a circuit diagram of a pixel according to some example embodiments.

FIG. 7 is a circuit diagram of a pixel according to some example embodiments.

FIG. 8 is a circuit diagram of a pixel according to some example embodiments.

FIG. 9 is a flowchart showing an operation of an image sensor according to some example embodiments.

FIG. 10 is a view showing an output current measured through operation (S1005) in FIG. 9.

FIG. 11A is a graph showing a result obtained through operation (S1007) of FIG. 9, and FIG. 11B is a circuit diagram of a pixel and which is explanatory of operation (S1007).

FIG. 12 is a graph showing a result obtained through operation (S1009) of FIG. 9.

FIG. 13 is a block diagram showing an electronic system according to some example embodiments.

### DETAILED DESCRIPTION

In the following detailed description, some example embodiments of the present disclosure have been shown and described, simply by way of illustration. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification. The sequence of operations is not limited to the order presented in the claims or figures unless specifically indicated otherwise. The order of operations may be changed, several operations may be merged, certain operations may be divided, and specific operations may not be performed.

As used herein, the singular forms “a”, “an” and “the” are intended to include the plural forms as well, unless the context clearly indicates otherwise. Terms including ordinal numbers such as first, second, and the like will be used only to describe various components, and are not to be interpreted as limiting these components. The terms are only used to differentiate one component from other components.

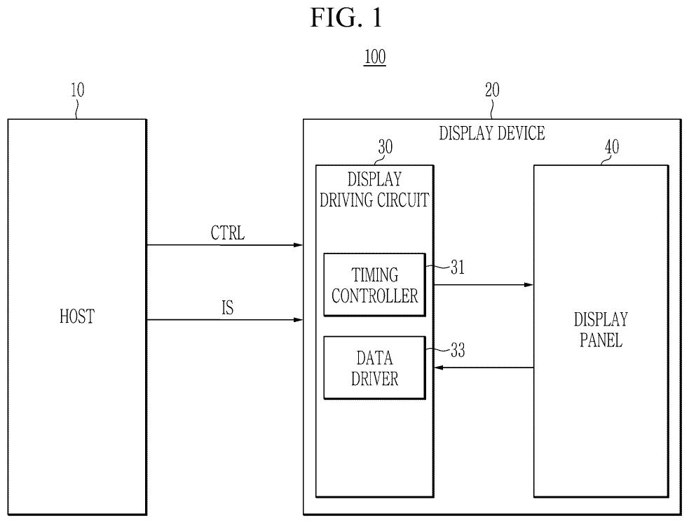

FIG. 1 is a block diagram showing a display system according to some example embodiments.

In some example embodiments, a display system 100 may be mounted on an electronic device having an image display function. For example, the electronic device may include smart phones, tablet personal computers, portable multimedia players (PMPs), cameras, wearable devices, televisions, digital video disk (DVD) players, a set-top box, a robot, a drone, various medical devices, navigation devices, global positioning system (GPS) receivers, vehicle devices, or various measuring devices.

Referring to FIG. 1, the display system 100 may include a host 10 and a display device 20. The display device 20 may include a display driving circuit 30 and a display panel 40.

The host 10 may control the display system 100 overall. The host 10 may generate an input image signal IS to be displayed on the display panel 40 and transmit an input image signal IS and a control instruction CTRL to the display driving circuit 30. The input image signal IS may include a frame data corresponding to each frame. The control instruction CTRL may include desired (and/or alternatively predetermined) information about luminance, gamma, frame frequency, etc.

The host 10 may be a graphics processor. However, the present disclosure is not limited thereto and the host 10 may be implemented with various types of processors such as a central processing unit (CPU), a microprocessor, a multimedia processor, an application processor, etc. In some example embodiments, the host 10 may be implemented as an integrated circuit (IC) or a system on chip (SOC).

The display device 20 may receive the input image signal IS from the host 10 and display the input image signal IS. The display device 20 may display 2D or 3D images to a user. In some example embodiments, the display device 20 may be a device in which the display driving circuit 30 and the display panel 40 are implemented as a single module. For example, the display driving circuit 30 may be mounted on the substrate of the display panel 40, or the display driving circuit 30 and the display panel 40 may be electrically connected through a connecting member such as a flexible printed circuit board (FPCB).

The display device 20 may perform display operations and pixel characteristic measurement operations. In some example embodiments, when the display device 20 performs the display operation, the display device 20 may display an image corresponding to the input image signal IS received from the host 10. When the display device 20 performs the display operation, the display device 20 may compensate for an image data corresponding to the input image signal IS based on a pixel characteristic data PXD.

In some example embodiments, when the display device 20 performs the pixel characteristic measurement operation, the display device 20 may generate the pixel characteristic data PXD based on an internal measurement reference voltage. For example, the display device 20 may perform a pixel characteristic measurement operation during a vertical blank period in which the display device 20 does not display an image. For example, since characteristics of elements included in the pixel may change over time, the display device 20 may measure the pixel characteristic every specific periods in order to accurately display the image. For example, the pixel characteristic may be a value of the current output from the pixel depending on the voltage applied to the pixel.

The display device 20 may include a display panel 40 and a display driving circuit 30.

The display panel 40 may display the image to the user according to the input image signal IS received from the host 10. The display panel 40 may be one of the display devices that receives an electrically transmitted video signal and displays the 2D image, and may for example be a thin film transistor liquid crystal display (TFT-LCD), an organic light-emitting diode (OLED) display, a field emission display, a plasma display panel, etc. In some example embodiments, there may be one or more display panels 40.

The display driving circuit 30 may generate a plurality of analog signals to drive the display panel 40 based on the input image signal IS received from the host 10. For example, the plurality of analog signals may include a plurality of gate signals and a plurality of data signals that drive the plurality of pixels included in the display panel 40. The display driving circuit 30 may provide the plurality of gate signals and the plurality of data signals to the plurality of pixels. The display panel 40 may emit an image light corresponding to the input image signal IS by a signal provided by the display driving circuit 30.

In some example embodiments, the display driving circuit 30 may include a timing controller 31 and a data driver 33.

The timing controller 31 may control the driving timing of the display driving circuit 30 based on the control instruction CTRL received from the host 10. The timing controller 31 may perform various image processing on the input image signal IS received from the host 10 to change the format of the image data and to reduce a power consumption.

In some example embodiments, the timing controller 31 may compensate the data voltage that the data driver 33 applies to the display panel 40 in response to the input image signal IS based on the characteristics of each of the plurality of pixels. Here, the characteristic of the pixel may be the value of the output current according to the voltage applied to the pixel. The characteristic of the pixel is not limited thereto, and may be the value of the output voltage according to the voltage applied to the pixel. In some example embodiments, the characteristic of the pixel may be an information indicating the degree of the degradation for the pixel. For example, the characteristic of the pixel may include an information about a degree of a degradation of the organic light-emitting diodes (OLEDs) or the transistors included in the pixel.

The data driver 33 may apply the data signal corresponding to the input image signal IS to the display panel 40 under the control of the timing controller 31.

In some example embodiments, the data driver 33 may measure the characteristics of each of the plurality of pixels. For example, the data driver 33 may apply a data signal (e.g., a first data signal) corresponding to a desired (and/or alternatively predetermined) measurement reference voltage to a selection pixel, which is one of the plurality of pixels. The data driver 33 may receive a return signal output from the selection pixel in response to the data signal. The return signal may include a leakage current output from non-selection pixels other than the selection pixels among the plurality of pixels. For example, the non-selection pixel may be a pixel that shares a data line and a return line connected to the selection pixel.

In some example embodiments, the data driver 33 may measure the characteristics of the selection pixels based on the data signal and the return signal. For example, the data driver 33 may perform a partial differentiation for the data signal applied to the pixel for the return signal as a variable to remove the influence of terms including the leakage current, and perform an indefinite integration with the data signal as a variable for the partially differentiated value. Accordingly, the data driver 33 may obtain a data about the pixel current output from the selection pixel according to the data signal applied to the selection pixel. The data driver 33 may transmit the characteristic of the selection pixel to the timing controller 31.

The timing controller 31 may compensate the data voltage (e.g., the second data signal) that the data driver 33 applies to the display panel 40 in response to the input image signal IS based on the characteristic of the selection pixel received from the data driver 33. Thus, the overall intensity of the light emitted from the display panel 40 may be corrected and made more uniform, increasing quality of the displayed image.

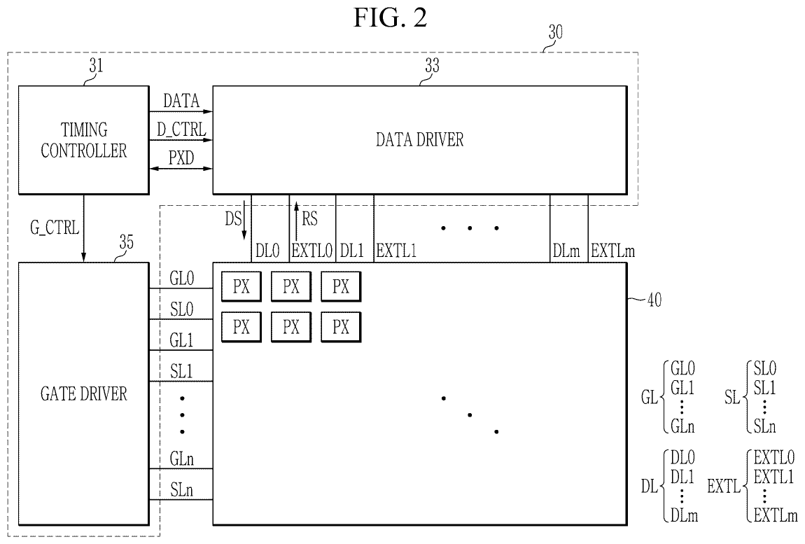

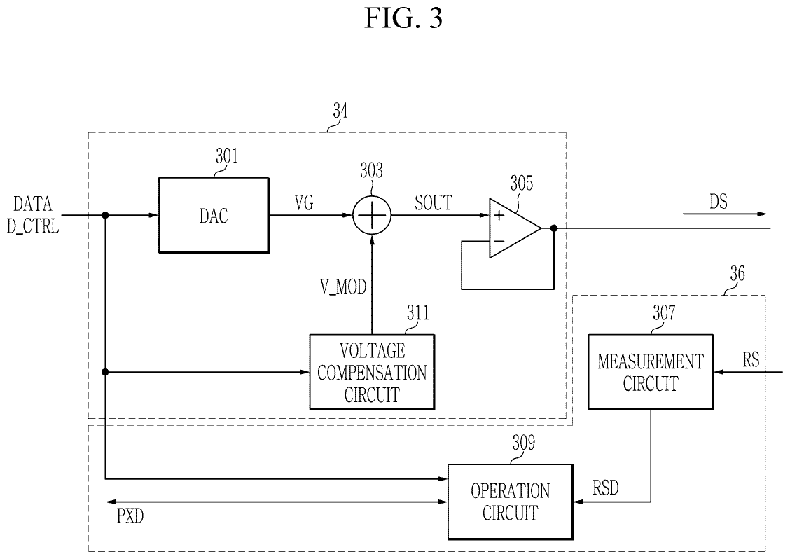

FIG. 2 is a block diagram showing a display device according to some example embodiments. FIG. 3 is a block diagram showing a configuration of a data driver according to some example embodiments.

As shown in FIG. 2, the display panel 40 may include a plurality of signal lines, for example a plurality of gate lines GL, a plurality of data lines DL, a plurality of sensing lines SL, and a plurality of return lines EXTL. The display panel 40 is connected to a plurality of signal lines and may include a plurality of pixels PX arranged in a matrix format. The display panel 40 may display an image based on the data signal DS received from the data driver 33 and the gate driving signal received from the gate driver 35.

In some example embodiments, the display panel 40 may include pixels implemented using organic light-emitting diode (OLED) cells. The OLED cell may receive the data signal DS of the data lines DL and the gate driving signal of the gate lines GL, and display the image in response to the operation of the organic light-emitting diode (OLED). However, it is not limited to this, and the display panel 40 may be implemented as another type of a flat panel display or a flexible display panel.

FIG. 2 shows that the pixel PX is connected to the data line DL, the gate line GL, the sensing line SL, and the return line EXTL, but according to some example embodiments, the connection structure of the signal lines of the pixels PX of the display device is not limited to this. For example, various signal lines may be additionally connected in accordance with the circuit structure of the pixel PX.

The display driving circuit 30 may include a timing controller 31, a data driver 33, and a gate driver 35.

The timing controller 31 may control the driving timing of the data driver 33 and the gate driver 35 based on the control instruction CTRL received from the host 10. The timing controller 31 may perform various image processing on the image data received from the host 10 to change the format of the image data and to reduce the power consumption.

The timing controller 31 may generate a data control signal D_CTRL based on the control instruction CTRL and the input image signal IS. The timing controller 31 may generate an image data DATA based on the input image signal IS. The timing controller 31 may transmit the data control signal D_CTRL and the image data DATA to data driver 33.

In some example embodiments, the timing controller 31 may store in advance the measurement reference voltage necessary to perform the pixel characteristic measurement operation. The timing controller 31 may generate the image data DATA based on the measurement reference voltage when the display device 20 performs the pixel characteristic measurement operation.

The timing controller 31 may receive the pixel characteristic data PXD from the data driver 33. The pixel characteristic data PXD may be a signal representing the electric characteristic of each or the plurality of pixels PXs provided in the display panel 40. In some example embodiments, the timing controller 31 may store the pixel characteristic data PXD received from the data driver 33. The timing controller 31 may transmit the pixel characteristic data PXD corresponding to the input image signal IS to the data driver 33 as the data control signal D_CTRL.

An ideal data indicating an ideal co-relationship between the data voltage and the pixel current may be preset in the timing controller 31 according to the settings of the display panel 40. For example, the ideal data may indicate the magnitude of the pixel current output from the pixel when a specific data voltage is applied to the pixel.

The timing controller 31 may generate a gate control signal G_CTRL based on the control instruction CTRL and the input image signal IS. The timing controller 31 may transmit the gate control signal G_CTRL to the gate driver 35.

The data driver 33 may receive the data control signal D_CTRL and the image data DATA from the timing controller 31. In some example embodiments, the data driver 33 may receive the image data DATA as a data unit corresponding to the plurality of pixels PX included in one horizontal line of the display panel 40. The image data DATA may include a gray information corresponding to each pixel PX to display the input image signal IS on the display panel 40. The data driver 33 may process the image data DATA in synchronization with the clock signal received from the timing controller 31.

In some example embodiments, the data driver 33 may apply the data signal DS corresponding to the desired (and/or alternatively predetermined) measurement reference voltage to the plurality of pixels PX through the plurality of data lines DL, and measure the electric characteristic of each of the plurality of pixels PX based on the return signal RS received from the plurality of return lines EXTL. For example, the return signal RS may be an output current output from the plurality of pixels PX.

FIG. 2 shows that the data driver 33 is connected to the display panel 40 through the m data lines DL and the m return lines EXTL, but the present disclosure is not limited to this and the display driving circuit 30 may also include the number of the return lines EXTL different from the number of the data lines DL.

Referring to FIG. 3 together, the data driver 33 may include a driving circuit 34 and a sensing circuit 36.

The driving circuit 34 may process the image data DATA based on the data control signal D_CTRL. In some example embodiments, the data driver 33 may convert the data signal DS in the form of an analog signal based on the image data DATA.

For example, the driving circuit 34 may convert the image data DATA provided from the timing controller 31 in the display operation into the data signal DS, for example data voltages. The driving circuit 34 may convert the image data DATA corresponding to the measurement reference voltage set internally by the timing controller 31 into the data signal DS during the pixel characteristic measurement operation.

The driving circuit 34 may be connected to the plurality of data lines DL. The driving circuit 34 may output the data signal DS to the display panel 40 through the plurality of data lines DL based on the data control signal D_CTRL. The driving circuit 34 may implement one frame by outputting the data signal DS corresponding to each of the plurality of data lines DL. In some example embodiments, the driving circuit 34 may output the plurality of data signals DS to the display panel 40 by a horizontal line unit.

For example, the driving circuit 34 may include a digital analog converter (DAC) 301, an adder 303, an AMP 305, and a voltage compensation circuit 311.

The DAC 301 may receive the image data DATA from the timing controller 31 and generate a gamma voltage VG corresponding to the image data DATA. In some example embodiments, the DAC 301 may generate 256 gamma voltages (VG<255:0>). The DAC 301 may transmit the gamma voltage VG to the adder 303. The voltage compensation circuit 311 may generate a compensation voltage V_MOD based on the data control signal D_CTRL and the image data DATA received from the timing controller 31. The compensation voltage V_MOD may be a value desired (and/or alternatively predetermined) based on the pixel characteristic data PXD and the image data DATA. In some example embodiments, the timing controller 31 may control the voltage compensation circuit 311 so that the data voltage applied based on the pixel characteristic data PXD corresponds to the desired (and/or alternatively predetermined) ideal data. For example, the voltage compensation circuit 311 may generate a compensation voltage V_MOD based on the difference between the voltage value of the ideal data corresponding to the image data DATA and the voltage value of the pixel characteristic data PXD corresponding to the image data DATA.

In some example embodiments, the voltage compensation circuit 311 may receive the pixel characteristic data PXD directly from the operation circuit 309 of the sensing circuit 36 and generate the compensation voltage V_MOD based on the received pixel characteristic data PXD. The voltage compensation circuit 311 may transmit the compensation voltage V_MOD to the adder 303.

The adder 303 may receive the gamma voltage VG from DAC 301 and the compensation voltage V_MOD from the voltage compensation circuit 311. The adder 303 may generate an output voltage SOUT by adding the received gamma voltage VG and the compensation voltage V_MOD. The adder 303 may transmit the output voltage SOUT to the output buffer 305.

The output buffer 305 may buffer (a voltage or current buffering) the received output voltage SOUT, and output the buffered voltage as a data signal DS to the display panel 40.

The sensing circuit 36 may generate the pixel data PXD indicating the pixel characteristic of the corresponding pixel PX based on the image data DATA and the plurality of return signals RS corresponding to each of the plurality of data signals DS. The sensing circuit 36 may transmit the pixel data PXD to the timing controller 31. In some example embodiments, the sensing circuit 36 may generate the pixel data PXD when the display device 20 performs the pixel characteristic measurement operation. For example, the sensing circuit 36 may measure the characteristic of the plurality of pixels PX periodically or nonperiodically. In some example embodiments, the pixel characteristic measurement operation may be performed in the manufacturing operation of the display device, a boot section after a power-on of the display system 100, an end section of a power-off, or a dummy section (or a vertical blank section) between display periods of the display panel 40. In some example embodiments, the pixel characteristic measurement operation may be performed with only a screen of the display device 20 turned off while a power is being applied to the display system (100 in FIG. 1).

The sensing circuit 36 may be connected to the plurality of return lines EXTL and receive the plurality of return signals RS output from the display panel 40 through the plurality of return lines EXTL in response to the data signal DS. The plurality of return signals RS may be a signal actually output from the display panel 40 in response to the image data DATA.

For example, the sensing circuit 36 may include a measurement circuit 307 and an operation circuit 309.

The measurement circuit 307 may sense the current output from the display panel 40 as the driving circuit 34 applies the data signal DS to the pixel PX. Here, the data signal DS may be a signal corresponding to a measurement reference voltage desired (and/or alternatively predetermined) in the timing controller 31. The measurement circuit 307 may convert the sensing current into a return signal data RSD and output the return signal data RSD to the operation circuit 309. In some example embodiments, the return signal data RSD may be a data (e.g., a function) representing the co-relationship between the applying data signal DS and the sensing current.

The measurement circuit 307 is shown as sensing the current flowing through the driving transistor, but the present disclosure is not limited to this and the measurement circuit 307 may also measure the magnitude of the voltage applied to the driving transistor and arbitrary elements indicating the characteristic of the pixel PX.

The operation circuit 309 may generate the pixel characteristic data PXD based on the return signal data RSD output from the measurement circuit 307 and the image data DATA corresponding to the measurement reference voltage. For example, the pixel characteristic data PXD may be a data representing the co-relationship between the data signal DS corresponding to the image data DATA and the return signal data RSD.

In some example embodiments, the operation circuit 309 may perform a partial differentiation on the data signal DS as a variable for applying the return signal data RSD to the pixel, and perform an indefinite integration on the partially differentiated value with the data signal DS as a variable to obtain the pixel characteristic data PXD.

The operation circuit 309 may transmit the pixel characteristic data PXD to the timing controller 31. As described above, the timing controller 31 and the driving circuit 34 may correct the data signal DS to be applied to the display panel 40 based on the pixel characteristic data PXD.

Again referring to FIG. 2, the gate driver 35 may drive the plurality of gate lines GL of the display panel 40 based on the gate control signal G_CTRL received from the timing controller 31. The gate driver 35 may provide the gate voltage to each of the plurality of gate lines GL based on the gate control signal G_CTRL. For example, the gate driver 35 may provide pulses of a gate-on voltage to the corresponding gate lines GL during the corresponding driving period based on the gate control signal G_CTRL. The gate driver 35 may output the gate control signal G_CTRL to the display panel 40 through the plurality of gate lines GL.

The gate driver 35 may drive the plurality of sensing lines SL of the display panel 40 based on the gate control signal G_CTRL received from the timing controller 31. The gate driver 35 may provide the sensing voltage to each of the plurality of sensing lines SL based on the gate control signal G_CTRL. For example, the gate driver 35 may provide the pulses of the sensing on voltage to the corresponding sensing line SL during the corresponding driving period based on the gate control signal G_CTRL. The gate driver 35 may output the gate control signal G_CTRL to display panel 40 through the plurality of sensing lines SL.

FIG. 2 shows that the gate driver 35 is connected to the display panel 40 through the n gate lines GL and the n sensing lines SL, but the present disclosure is not limited to this and the display driving circuit 30 may include the number of the sensing lines SL different from the number of the gate lines GL.

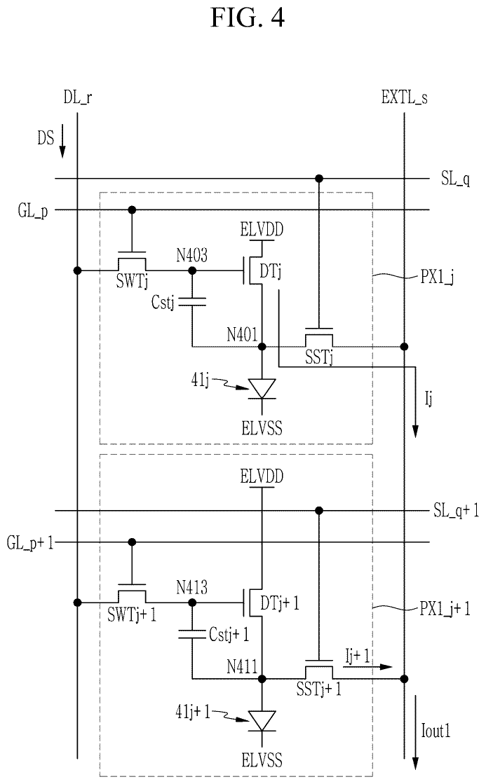

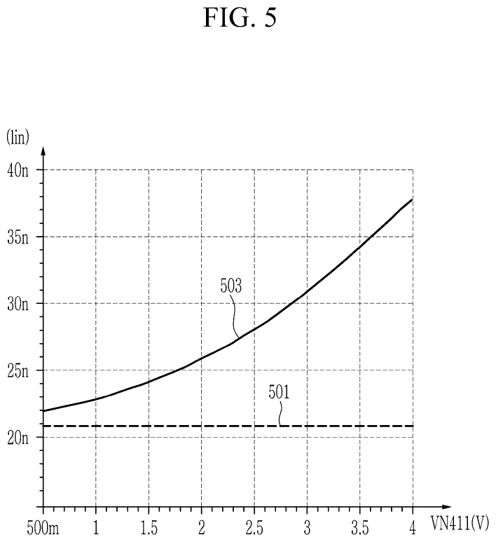

FIG. 4 is a circuit diagram of a pixel according to some example embodiments. FIG. 5 is a view showing a current flowing through a selection pixel and a non-selection pixel according to a voltage applied to a non-selection pixel.

For example, the display panel (40 in FIG. 2) may include a plurality of pixels. FIG. 4 is a view showing a pixel PX1_j and a pixel PX1_(j+1) that are arbitrarily positioned adjacent to each other.

As shown in FIG. 4, the pixel PX1_j may include a switching transistor SWTj, a driving transistor DTj, an OLED 41j, a storage capacitor Cstj, and a sensing transistor SSTj. The switching transistor SWTj, the driving transistor DTj, the OLED 41j, the storage capacitor Cstj, and the sensing transistor SSTj may be one of a PMOS transistor and an NMOS transistor. In some example embodiments as shown in FIG. 4 all three transistors may be composed of the NMOS transistors.

A first driving voltage ELVDD and a second driving voltage ELVSS may be applied to the pixel PX1_j. The first driving voltage ELVDD may be relatively higher than the second driving voltage ELVSS.

The switching transistor SWTj, the sensing transistor SSTj, and the driving transistor DTj may be formed of an amorphous silicon (a-Si) thin film transistor (TFT), a poly-silicon (poly-Si) TFT, an oxide TFT, or an organic TFT, etc.

The pixel PX1_j may be connected to a gate line GL_p, a data line DL_r, a sensing line SL_q, and a return line EXTL_s corresponding thereto. In FIG. 2, the pixel PX is shown as being connected to one data line DL_r (r is an integer between 1 and m) and one gate line GL_p (p is an integer between 1 and n), but the switching transistor SWTj may be connected to the gate line GL_p and the data line DL_r. The switching transistor SWTj may be controlled by the gate voltage applied through the gate line GL1. The turned on switching transistor SWTj may provide the data signal DS supplied through the data line DL_r to the gate node N403 of the driving transistor DTj.

The sensing transistor SSTj may be connected to the sensing line SL_q and the return line EXTL_s and may be controlled by the sensing voltage applied through the sensing line SL_q. The sensing transistor SSTj that is turned on may supply the initialization voltage to the source node N401 of the driving transistor DTj. The turned on sensing transistor SSTj may transmit the voltage supplied to the first node N401 to the return line EXTL_s.

The storage capacitor Cstj, by storing the difference between the data voltage applied to the gate node N403 of the driving transistor DTj through the switching transistor SWTj and the initialization voltage supplied to the source node N401 of the driving transistor DTj through the sensing transistor SSTj, may supplying a constant driving voltage (e.g., a gate-source voltage of the driving transistor DTj) to the driving transistor DTj during a desired (and/or alternatively predetermined) period, for example, one frame.

The first driving voltage ELVDD may be applied to the drain node of the driving transistor DTj, and the driving transistor DTj may supply a current Ij proportional to the driving voltage, which is the difference between the voltage of the gate node N403 of the driving transistor DTj and the voltage of the source node N401, to the OLED 41j.

The OLED 41j may include an anode connected to the source node N401 of the driving transistor DTj, a cathode to which the second driving voltage ELVSS is applied, and an organic emission layer between the cathode and the anode. The cathode may be a common electrode shared by the plurality of pixels PX. When the driving current Ij is supplied from the driving transistor DTj, light may be generated from the organic emission layer of the OLED 41j. The intensity of light may be proportional to the driving current Ij.

The explanation described with reference to the pixel PX1_j may be similarly applied to the pixel PX1_(j+1) unless otherwise specified.

In the display operation, the switching transistor SWTj may supply the data signal DS applied through the data line DL_r to the driving transistor DTj, and the sensing transistor SSTj may be turned on. The current Ij proportional to the difference between the voltage of the gate node N403 and the voltage of the source node N401 of the driving transistor DTj, that is, the driving voltage may flow through the OLED 41j. The OLED 41j may output light according to the driving current Ij corresponding to the image data. Likewise, the OLED 41(j+1) may also output light according to the driving current I(j+1) corresponding to the image data.

During the pixel characteristic measurement operation, the timing controller 31 may determine the pixel PX1_j as a selection pixel for measuring the pixel characteristic. The switching transistor SWTj may supply a data signal DS corresponding to the measurement reference voltage applied through the data line DL_r to the driving transistor DTj. During the pixel characteristic measurement operation, the sensing transistor SSTj corresponding to the selection pixel PX1_j may be turned on by the sensing on voltage. Accordingly, the sensing transistor SSTj may output the current from the driving transistor DTj or the OLED 41j to the return line EXTL_s.

A sensing off voltage may be applied to the sensing transistor corresponding to the non-selected pixel that is not selected among the plurality of pixels. For example, the sensing off voltage may be applied to the sensing transistor SST_(j+1) of the pixel PX1_(j+1). Accordingly, the sensing transistor SST_(j+1) is turned off and theoretically there should be no current flowing to the return line EXTL_s. However, in reality, the sensing transistor SST_(j+1) is not completely turned off due to the device characteristics, so a leakage current I(j+1) is generated, and the leakage current I(j+1) flows to the return line EXTL_s. For example, the leakage current I(j+1) may be 10 pA.

FIG. 4 shows the pixel PX1_(j+1) as an example of the non-selection pixel, but the present disclosure is not limited thereto and the rest of the pixels except the pixel PX1_j among the plurality of pixels may be the non-selection pixel. Accordingly, the output current Iout1 flowing through the return line EXTL_s may be the sum of the current Ij output from the pixel PX1_j, which is the selection pixel, and the leakage current output from the non-selection pixel.

Referring to FIG. 5, a first graph 501 is a graph showing the current Ij flowing in the selection pixel according to the voltage of the first node N411 of the non-selection pixel. A second graph 503 is a graph showing the leakage current I(j+1) flowing according to the voltage of the first node N411.

As shown in the first graph 501, even if the voltage of the first node N411 increases, the magnitude of the current Ij flowing through the sensing transistor SSTj of the selection pixel PX1_j may be constant. However, as shown in the second graph 503, as the voltage of the first node N411 increases, the current I(j+1) flowing through the sensing transistor SST(j+1) of the non-selection pixel PX1_(j+1) may increase proportionally. Accordingly, as the voltage of the first node N411 increases, the influence of the leakage current I(j+1) on the output current Iout1 may increase. The voltage of the first node N411 is different for each pixel depending on the status of the non-selection pixel, so there is a problem in that it cannot be predicted.

The data driver (33 of FIG. 2) may determine one pixel PX1_j among the plurality of pixels as the selection pixel to generate the correct data signal, measure the characteristic of the selection pixel by measuring the output current Iout1 by applying a desired (and/or alternatively predetermined) voltage to the selection pixel, and compensate the image data value based on the pixel characteristic. However, because the output current of the selection pixel includes the leakage current of the non-selection pixel, the data driver 33 may not accurately measure the characteristic of the selection pixel PX1_j. Therefore, the data driver 33 may perform the processing to obtain the current Ij flowing in the selection pixel based on the output current Iout1. Therefore, the data driver 33 may accurately measure the characteristic of the selection pixel.

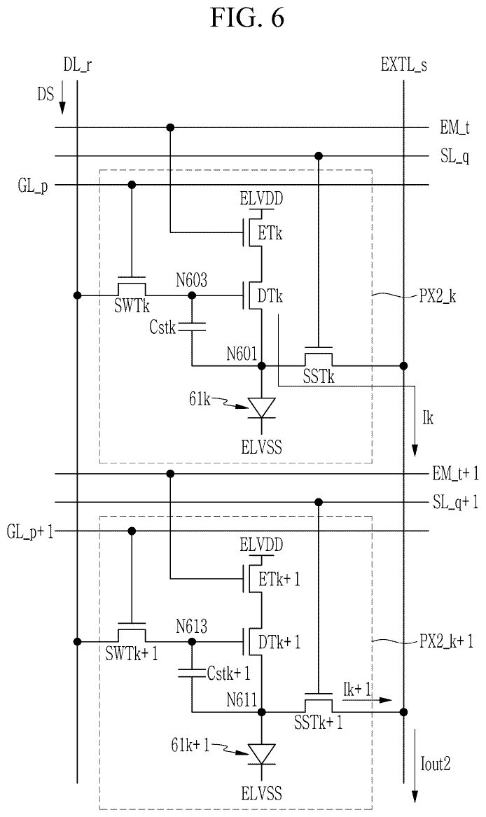

FIG. 6 is a circuit diagram of a pixel according to some example embodiments.

The display panel (40 of FIG. 2) may include a plurality of pixels. FIG. 6 is the view showing a pixel PX2_k and a pixel PX2_(k 1) positioned arbitrarily adjacent to each other. As shown in FIG. 6, the pixel PX2_k may include a switching transistor SWTk, a driving transistor DTk, a light emitting transistor ETk, an OLED 61k, a storage capacitor Cstk, and a sensing transistor SSTk.

Unless otherwise stated, referring to FIG. 4, the contents on the switching transistor SWTk, the driving transistor DTk, the OLED 41k, the storage capacitor Cstk, and the sensing transistor SSTk described above may be equally or similarly applied to each of the switching transistor SWTj, the driving transistor DTj, the OLED 41j, the storage capacitor Cstj, and the sensing transistor SSTj.

The light emitting transistor ETk may be connected to the light emitting line EM_t and the drain of the driving transistor DTk and be controlled by the light emitting voltage applied to the light emitting line EM_t. The light emitting transistor ETk that is turned on may transmit the first driving voltage ELVDD to the drain of the driving transistor DTk.

The driving transistor DTk may supply current Ik proportional to the driving voltage, which is the difference between the voltage of the gate node N603 of the driving transistor DTk and the voltage of the source node N601, to the OLED 61k.

The explanation described with reference to the pixel PX2_k may be similarly applied to the pixel PX2_(k+1) unless otherwise specified.

In the display operation, the switching transistor SWTk may supply the data signal DS applied through the data line DL_r to the driving transistor DTk. At this time, the light emitting transistor ETk and the sensing transistor SSTk may be turned on. The current Ik proportional to the difference between the voltage of the gate node N603 of the driving transistor DTk and the voltage of the source node N601, that is, the driving voltage may flow in the OLED 61k. The OLED 61k may output light according to the driving current Ik corresponding to the image data. Likewise, the OLED 61(k+1) may also output light according to the driving current Ik+1 corresponding to the corresponding image data.

During the pixel characteristic measurement operation, the timing controller 31 may determine the pixel PX2_k as the selection pixel for measuring the pixel characteristic. The switching transistor SWTk may supply the data signal DS corresponding to the measurement reference voltage applied through the data line DL_r to the driving transistor DTk, and the light emitting transistor ETk may be turned on. During the pixel characteristic measurement operation, the sensing transistor SSTk corresponding to the selection pixel PX2_k may be turned on by the sensing on voltage. Accordingly, the sensing transistor SSTk may output the current from the driving transistor DTk or the OLED 61k to the return line EXTL_s.

A sensing off voltage may be applied to the sensing transistor corresponding to the non-selection pixel that is not selected among the plurality of pixels. For example, a sensing off voltage may be applied to the sensing transistor SST_(k+1) of the pixel PX2_(k+1). Accordingly, the sensing transistor SST_(k+1) is turned off and theoretically there should be no current flowing to the return line EXTL_s. However, in reality, due to the device characteristics of the sensing transistor SST_(k 1), it is not completely turned off, resulting in the leakage current I(k+1), and the leakage current I(k+1) may flow to the return line EXTL_s.

In FIG. 6, as an example of the non-selection pixel, the pixel PX2_(k+1) is shown, but the present disclosure is not limited thereto and all pixels except the pixel PX2_k among the plurality of pixels may be the non-selection pixel. Accordingly, the output current Iout2 flowing through the return line EXTL_s may be the sum of the current Ik output from the pixel PX2_k, which is the selection pixel, and the leakage current output from the non-selection pixel.

The data driver (33 in FIG. 2) may determine one pixel PX2_k among the plurality of pixels as the selection pixel to generate the accurate data signal, measure the output current Iout2 by applying a desired (and/or alternatively predetermined) voltage to the selection pixel to measure the characteristic of the selection pixel, and compensate the image data value based on the characteristic of the pixel. However, because the output current of the selection pixel includes the leakage current of the non-selection pixel, the data driver 33 may not accurately measure the characteristic of the selection pixel PX2_k. Therefore, the data driver 33 may perform the processing to obtain the current Ik flowing in the selection pixel based on the output current Iout2. Therefore, the data driver 33 may accurately measure the characteristic of the selection pixel.

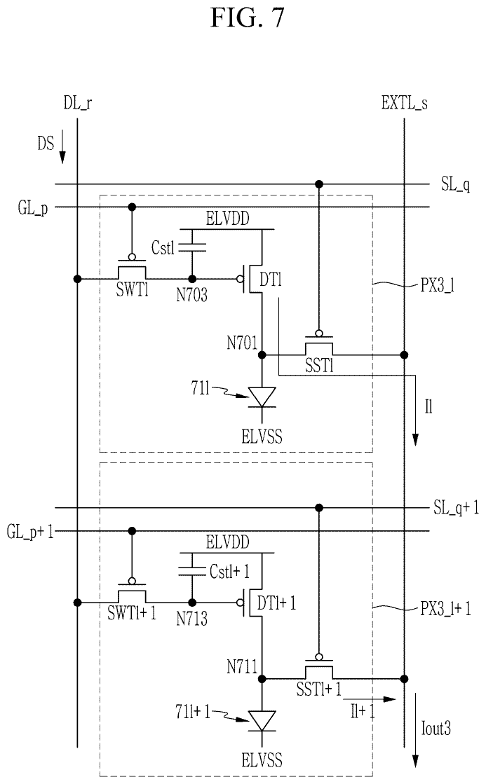

FIG. 7 is a circuit diagram of a pixel according to some example embodiments.

The display panel (40 of FIG. 2) may include a plurality of pixels. FIG. 7 is the drawing showing a pixel PX3_l and a pixel PX3_(l+1) positioned arbitrarily adjacent to each other. As shown in FIG. 7, the pixel PX3_l may include a switching transistor SWTl, a driving transistor DTI, an OLED 71l, a storage capacitor Cstl, and a sensing transistor SSTl. The switching transistor SWTl, the driving transistor DTI, the OLED 71l, the storage capacitor Cstl, and the sensing transistor SSTl may be one of a PMOS transistor and an NMOS transistor. In some example embodiments as shown in FIG. 7, all three transistors are PMOS transistors.

The first driving voltage ELVDD and the second driving voltage ELVSS may be applied to the pixel PX3_l. The first driving voltage ELVDD may be relatively higher than the second driving voltage ELVSS.

The switching transistor SWTl, the sensing transistor SSTl, and the driving transistor DTl may be an amorphous silicon (a-Si) TFT, a poly-silicon (poly-Si) TFT, an oxide TFT, or an organic TFT, etc.

The pixel PX3_l may be connected to the corresponding gate line GL_p, data line DL_r, sensing line SL_q, and return line EXTL_s. The switching transistor SWTl may be connected to the gate line GL_p and the data line DL_r. The switching transistor SWTl may be controlled by the gate voltage applied through the gate line GL1. The turned on switching transistor SWTl may provide the data signal DS supplied through the data line DL_r to the gate node N703 of the driving transistor DTI.

The sensing transistor SSTl may be connected to the sensing line SL_q and the return line EXTL_s, and be controlled by the sensing voltage applied through the sensing line SL_q. The turned on sensing transistor SSTl may supply the initialization voltage to the source node N701 of the driving transistor DTI. The turned on sensing transistor SSTl may transmit the voltage supplied to the first node N701 to the return line EXTL_s.

The storage capacitor Cstl may supply a constant driving voltage to the driving transistor DTl during a desired (and/or alternatively predetermined) section, for example, one frame, by storing the difference between the voltage applied to the gate node N703 of the driving transistor DTl and the first driving voltage ELVDD.

The first driving voltage ELVDD is applied to the drain node of the driving transistor DTI, and the driving transistor DTl may supply a current Il proportional to the difference between the voltage of the gate node N703 of the driving transistor DTl and the voltage of the source node N701, that is, the driving voltage to the OLED 71l.

The OLED 71l may include an anode connected to the source node N701 of the driving transistor DTI, a cathode to which the second driving voltage ELVSS is applied, and an organic emission layer between the cathode and the anode. The cathode may be a common electrode shared by the plurality of pixels PX. When the driving current Il is supplied from the driving transistor DTI, light may be generated from the organic emission layer of OLED 71l. The intensity of light may be proportional to the driving current II.

The explanation described with reference to the pixel PX3_l may be similarly applied to the pixel PX3_(l+1) unless otherwise specified.

In the display operation, the switching transistor SWTl may supply the data signal DS applied through the data line DL_r to the driving transistor DTI, and the sensing transistor SSTl may be turned on. A current Il proportional to the difference between the voltage of the gate node N703 of the driving transistor DTl and the voltage of the source node N701, that is, the driving voltage may flow in the OLED 71l. The OLED 71l may output light according to the driving current Il corresponding to the image data. Likewise, the OLED 71(l+1) may also output light according to the driving current Il+1 corresponding to the corresponding image data.

During the pixel characteristic measurement operation, the timing controller 31 may determine the pixel PX3_l as the selection pixel for measuring the pixel characteristic. The switching transistor SWTl may supply the data signal DS corresponding to the measurement reference voltage applied through the data line DL_r to the driving transistor DTI. During the pixel characteristic measurement operation, the sensing transistor SSTl corresponding to the selection pixel PX3_l may be turned on by the sensing on voltage. Accordingly, the sensing transistor SSTl may output the current from the driving transistor DTl or the OLED 71l to the return line EXTL_s.

A sensing off voltage may be applied to the sensing transistor corresponding to the non-selection pixel that is not selected among the plurality of pixels. For example, a sensing off voltage may be applied to the sensing transistor SST_(l+1) of pixel PX3_(l+1). Accordingly, the sensing transistor SST_(l+1) is turned off and theoretically there should be no current flowing to the return line EXTL_s. However, in reality, due to the device characteristic of the sensing transistor SST_(l+1), it is not completely turned off, resulting in the leakage current I(l+1), and the leakage current I(l+1) flows to the return line EXTL_s.

In FIG. 7, the pixel PX3_(l+1) is shown as an example of the non-selection pixel, but the present disclosure is not limited to this, and all pixels other than the pixel PX3_l among the plurality of pixels may be the non-selection pixel. Accordingly, the output current Iout3 flowing through the return line EXTL_s may be the sum of the current Il output from the pixel PX3_l, which is the selection pixel, and the leakage current output from the non-selection pixel.

In order to generate the accurate data signal, the data driver (33 in FIG. 2) may determine one pixel PX3_l among the plurality of pixels as the selection pixel, measure the output current Iout3 by applying the desired (and/or alternatively predetermined) voltage to the selection pixel to measure the characteristic of the selection pixel, and compensate the image data value based on the pixel characteristic. However, because the output current of the selection pixel includes the leakage current of the non-selection pixel, the data driver 33 may not accurately measure the characteristic of the selection pixel PX3_l. Therefore, the data driver 33 may perform the processing to obtain the current Il flowing in the selection pixel based on the output current Iout3. Therefore, the data driver 33 may accurately measure the characteristic of the selection pixel.

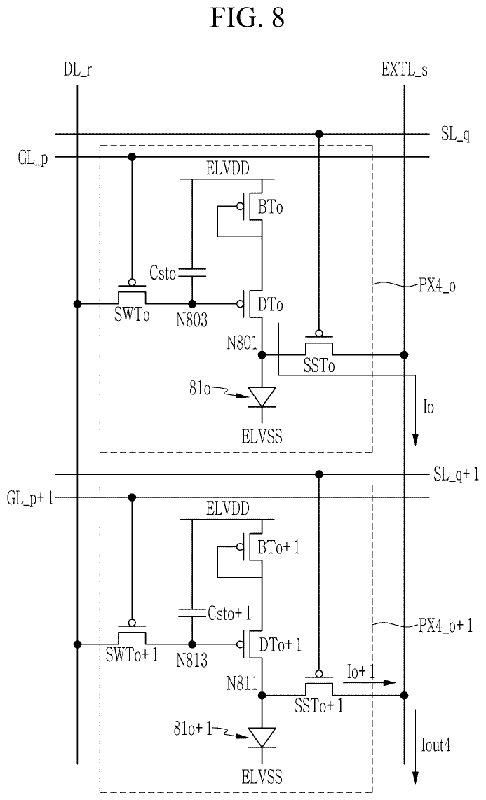

FIG. 8 is a circuit diagram of a pixel according to some example embodiments.

For example, the display panel (40 in FIG. 2) may include a plurality of pixels. FIG. 8 is the drawing showing a pixel PX4_o and a pixel PX4_(o+1) positioned arbitrarily adjacent to each other. As shown in FIG. 8, the pixel PX4_o may include a switching transistor SWTo, a driving transistor DTo, a bias transistor BTo, an OLED 81o, a storage capacitor Csto, and a sensing transistor SSTo.

Unless otherwise stated, referring to FIG. 4, the contents of the switching transistor SWTo, the driving transistor DTo, OLED 41o, the storage capacitor Csto, and the sensing transistor SSTo described above may be equally or similarly applied to each of the switching transistor SWTj, the driving transistor DTj, the OLED 41j, the storage capacitor Cstj, and the sensing transistor SSTj.

The bias transistor BTo may be connected to a first driving voltage ELVDD line and the drain of the driving transistor DTo. The gate terminal and the drain terminal of the bias transistor BTo may be connected to the drain terminal of the driving transistor DTo. The bias transistor BTo may be self-biased.

The bias transistor BTo may reduce the magnitude of the difference between the voltage of the gate node N803 of the driving transistor DTo and the voltage of the source node N801 by performing the source degeneration on the driving transistor DTo. Accordingly, the bias transistor BTo may increase the range of the data that the pixels may output.

The driving transistor DTo may supply a current Io proportional to the difference between the voltage of the gate node N803 of the driving transistor DTo and the voltage of the source node N801, that is, the driving voltage to the OLED 81o.

The explanation described with reference to the pixel PX4_o may be similarly applied to the pixel PX4_(o+1) unless otherwise specified.

In the display operation, the switching transistor SWTo may supply the data signal DS applied through the data line DL_r to the driving transistor DTo, and the light emitting transistor ETo and the sensing transistor SSTo may be turned on. A current Io proportional to the difference between the voltage of the gate node N803 of the driving transistor DTo and the voltage of the source node N801, that is, the driving voltage may flow into the OLED 81o. The OLED 81o may output light according to the driving current Io corresponding to the image data. Likewise, the OLED 81(o+1) may also output light according to the driving current I(o+1) corresponding to the image data.

During the pixel characteristic measurement operation, the timing controller 31 may determine the pixel PX4_o as a selection pixel for measuring the pixel characteristic. The switching transistor SWTo may supply the data signal DS corresponding to the measurement reference voltage applied through the data line DL_r to the driving transistor DTo, and the light emitting transistor ETo may be turned on. During the pixel characteristic measurement operation, the sensing transistor SSTo corresponding to the selection pixel PX4_o may be turned on by the sensing on voltage. Accordingly, the sensing transistor SSTo may output the current from the driving transistor DTo or the OLED 81o to the return line EXTL_s.

A sensing off voltage may be applied to the sensing transistor corresponding to the non-selection pixel that is not selected among the plurality of pixels. For example, the sensing off voltage may be applied to the sensing transistor SST_(o+1) of the pixel PX4_(o+1). Accordingly, the sensing transistor SST_(o+1) is turned off and theoretically there should be no current flowing to the return line EXTL_s. However, in reality, based on the device characteristics thereof, the sensing transistor SST_(o+1) does not completely turn off, resulting in the leakage current I(o+1), and the leakage current I(o+1) may flow to the return line EXTL_s.

FIG. 8 shows the pixel PX4_(o+1) as an example of the non-selection pixel, but the present disclosure is not limited thereto and the rest of the pixels except for the pixel PX4_o among the plurality of pixels may be the non-selection pixel. Accordingly, the output current Iout4 flowing through the return line EXTL_s may be the sum of the current Io output from the pixel PX4_o, which is a selection pixel, and the leakage current output from the non-selection pixel.

The data driver (33 of FIG. 2) may determine one pixel PX4_o as the selection pixel among the plurality of pixels to generate the correct data signal, measure the characteristic of the selection pixel by measuring the output current Iout4 due to an application of a desired (and/or alternatively predetermined) voltage to the selection pixel, and compensate the image data value based on the characteristic of the pixel. However, because the output current of the selection pixel includes the leakage current of the non-selection pixel, the data driver 33 may not accurately measure the characteristic of the selection pixel PX4_o. Therefore, the data driver 33 may perform the processing to obtain the current Io flowing in the selection pixel based on the output current Iout4. Therefore, the data driver 33 may accurately measure the characteristic of the selection pixel.

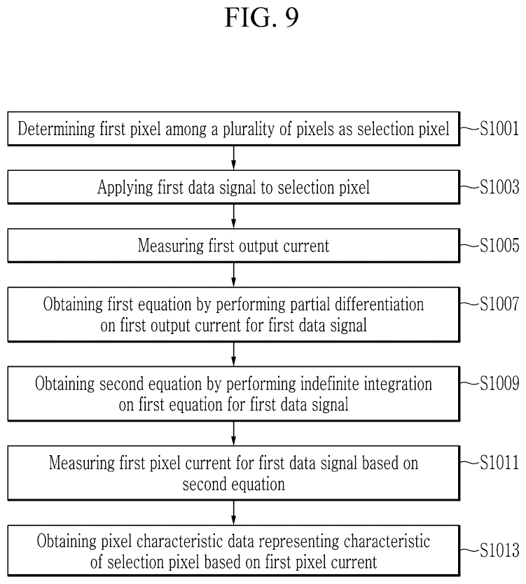

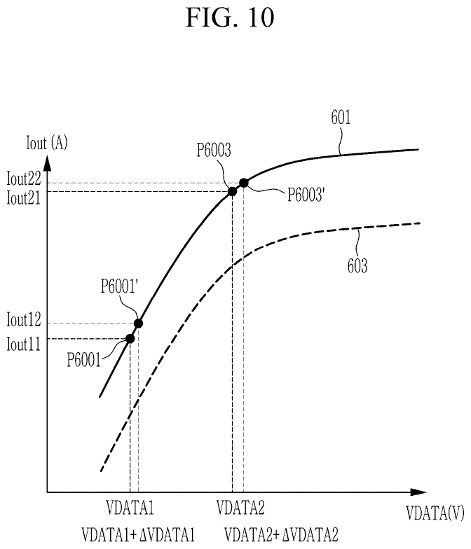

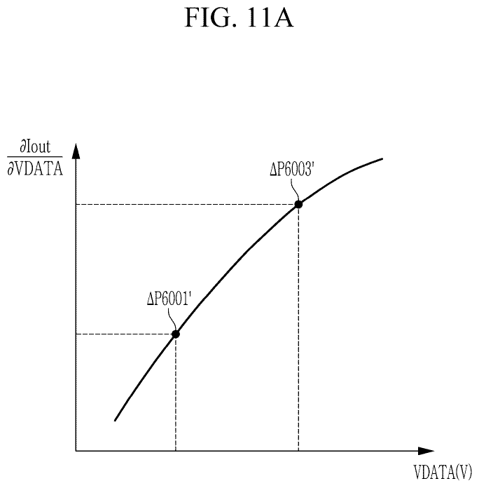

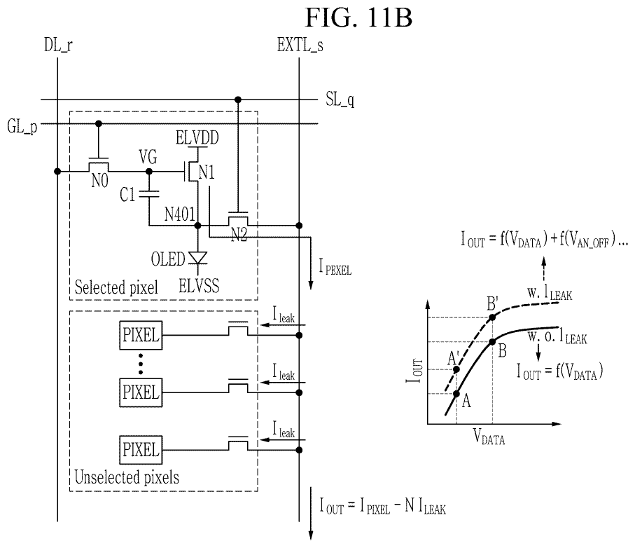

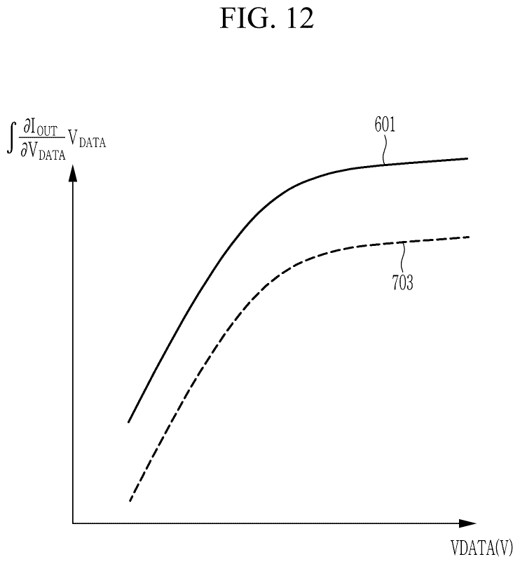

FIG. 9 is a flowchart showing an operation of an image sensor according to some example embodiments. FIG. 10 is a view showing an output current measured through operation (S1005) in FIG. 9. FIG. 11A is a graph showing a result obtained through operation (S1007) of FIG. 9, and FIG. 11B is a circuit diagram of a pixel such as shown in FIG. 4 and including output current Iout with respect to data voltage. FIG. 12 is a graph showing a result obtained through operation (S1009) of FIG. 9.

First, the timing controller (31 of FIG. 2) determines a first pixel of a plurality of pixels PX as a selection pixel (S1001).

The timing controller 31 applies the first data signal to the selection pixel through the data driver (33 in FIG. 2) (S1003).

For example, the timing controller 31 may control the gate driver (35 of FIG. 2) so that the gate-on voltage is applied to the first gate line connected to the selection pixel among the plurality of gate lines GL, and the sensing on voltage is applied to the first sensing line connected to the selection pixel among the plurality of sensing lines SL. Also, the timing controller 31 may control the driving circuit 34 of the data driver 33 so that a first data signal corresponding to a desired (and/or alternatively predetermined) measurement reference voltage is applied to the first data line connected to the selection pixel among the plurality of data lines DL.

The data driver 33 measures the first output current Iout (S1005) provided by the selection pixel responsive to the first data signal applied to the first sensing line connected to the selection pixel.

For example, the measurement circuit 307 of the data driver 33 may measure the first output current Iout output through the first return line connected to the selection pixel among the plurality of return lines EXTL. The first return line may also be connected to the plurality of non-selection pixels, excluding the selection pixel, among the pixels connected to the first data line. In some example embodiments, the first output current Iout may be the sum of the first pixel current Iout output through the first return line from the selection pixel based on the first data signal and the leakage current output through the first return line from the plurality of non-selection pixels.

Therefore, the first output current Iout may be expressed as Equation 1.

$$IOUT = f ( {V}_{DATA} ) + f ( w ) ( here , w is an arbitrary constant ) \qquad ( Equation 1 )$$

Referring to FIG. 10 together, the first graph 601 is a graph showing the output current according to the data voltage applied to the selection pixel. As shown in FIG. 10, the first point P6001 may be a point indicating that the first output current Iout11 (e.g., Iout_11) is output when applying the first data voltage VDATA1 to the selection pixel. The first point′ P6001′ may be a point indicating that the second output current Iout12 (e.g., another first output current) is output when applying the first data voltage′ (VDATA1+ΔVDATA1) (e.g., another first data voltage), which has a fine difference (e.g., is finely adjusted) from the first data voltage, to the selection pixel.

The second point P6003 may be a point indicating that the third output current Iout21 is output when applying the second data voltage VDATA2 to the selection pixel. The second point′ P6003′ may be a point indicating that the fourth output current Iout22 is output when applying the second data voltage′ (VDATA2+ΔVDATA2), which has a fine difference (e.g., is finely adjusted) from the second data voltage, to the selection pixel.

The measurement circuit 307 may measure (S1005) the output current based on the first point P6001 and the first point′ P6001′. For example, the equation for the output current may be obtained. Additionally, the measurement circuit 307 may measure the output current based on the second point P6003 and the second point′ P6003′.

The second graph 603 is a graph showing the ideal pixel current expected to be output from the selection pixel when applying the data signal to the selection pixel based on a desired (and/or alternatively predetermined) ideal data.

As shown in FIG. 10, there may be a difference between the first graph 601 and the second graph 603 due to a leakage current output from a non-selection pixel.

Again, referring to FIG. 9, the data driver 33 performs a partial differentiation of the first output current with respect to the first data signal to obtain a first equation (e.g., Equation 2) (S1007).

For example, the operation circuit 309 may perform a partial differentiation on the first output current Iout expressed in Equation 1 using the first data signal as a variable. For example, under the assumption that the pixel current flowing to the selection pixel may be affected only by the magnitude of the data signal applied to the selection pixel, the operation circuit 309 may perform a partial differentiation on the first output current Iout by using the first data signal as a variable. The result of the operation performed by the operation circuit 309 may be expressed as Equation 2 below.

$$\frac{\partial {I}_{OUT}}{\partial {V}_{DATA}} = \frac{\partial f ( {V}_{DATA} )}{\partial {V}_{DATA}} + \frac{\partial f ( w )}{\partial {V}_{DATA}} = \frac{\partial f ( {V}_{DATA} )}{\partial {V}_{DATA}} \qquad ( Equation 2 )$$

As the operation circuit 309 performs the partial differentiation with the first data signal as a variable for the first output current Iout, the remaining terms that do not include the first data signal may be removed. For example, the terms consisting of arbitrary constants in Equation 2 may be removed.

For example, regarding the partial differentiation, as may be understood with reference to FIG. 11B which corresponds to the pixel shown in FIG. 4, the output current may be characterized as

$${I}_{OUT} = {I}_{PIXEL} - N {I}_{LEAK} = I ( {V}_{DATA} ) + f ( w ) ,$$

wherein I_{PIXEL} is the current generated by the N1 transistor of the selected pixel shown in FIG. 11B and which equals f(V_{DATA})+f(V_{AN_OFF}), and ILEAK is the current generated by the N2 transistor of the unselected pixel shown in FIG. 11B and which equals f(V_{DATA})+f(w).

I_{PIXEL}(N1) and I_{LEAK(N2)} may be expressed as follows

$$\begin{matrix}{I}_{PIXEL ( N 1 )} = {I}_{0} exp ( \frac{{V}_{GS} - {V}_{TH}}{η {V}_{T}} ) ( 1 - exp ( - \frac{{V}_{DS}}{{V}_{T}} ) ) \\ = {I}_{0} exp ( \frac{{V}_{DATA} - {V}_{AN} - {V}_{TH}}{η {V}_{T}} ) ( 1 - exp ( - \frac{{V}_{D D} - {V}_{A N}}{{V}_{T}} ) )\end{matrix}$$

$$\begin{matrix}{I}_{LEAK ( N 2 )} = {I}_{0} exp ( \frac{{V}_{GS} - {V}_{TH}}{η {V}_{T}} ) ( 1 - exp ( - \frac{{V}_{DS}}{{V}_{T}} ) ) \\ = {I}_{0} exp ( \frac{0 - {V}_{TH}}{η {V}_{T}} ) ( 1 - exp ( - \frac{{V}_{AN \_ OFF} - {V}_{EXT}}{{V}_{T}} ) )\end{matrix}$$

V_{TH} refers to the threshold voltage of a MOSFET, which is the voltage at which the transistor turns on. V_{T} refers to the thermal voltage, which is a constant—for example, approximately 26 mV at room temperature. η is the sub-threshold coefficient, a constant that varies depending on the manufacturing process.

By partial differentiation with the data signal V_{DATA} as a variable, under the above noted assumption that the pixel current flowing to the selection pixel may be affected only by the magnitude of the data signal applied to the selection pixel, the terms consisting of arbitrary constants (e.g., the terms related to I_{LEAK(N2)}) may be removed as follows

$$\begin{matrix}\frac{\partial {I}_{OUT}}{\partial {V}_{DATA}} = \frac{\partial {I}_{PIXEL}}{\partial {V}_{DATA}} + N \frac{\partial {I}_{LEAK}}{\partial {V}_{DATA}} \\ = \frac{{I}_{0}}{η {V}_{T}} exp ( \frac{{V}_{DATA} - {V}_{AN} - {V}_{TH}}{η {V}_{T}} ) ( 1 - exp ( - \frac{{V}_{DD} - {V}_{AN}}{{V}_{T}} ) ) \\ = \frac{\partial {I}_{PIXEL}}{\partial {V}_{DATA}}\end{matrix}$$

to thus provide Equation 2.

Referring back to FIG. 11A together with FIGS. 9 and 10, the operation circuit 309 may obtain an equation for the output current by using the difference between the first point P6001 to which the first data voltage VDATA1 is applied and the first point′ P6001′ to which the first data voltage′ (VDATA1 ΔVDATA1) is applied, and perform a partial differentiation on the obtained equation. The first differential element (ΔP6001′), which is the result of performing a partial differentiation on the first point, may be expressed as Equation 3.

$$Δ P {6001}^{′} = \frac{\partial ( Iout 12 - Iout 11 )}{\partial {V}_{DATA}} = \frac{\partial ( f ( VDATA 1 + Δ VDATA 1 ) - f ( VDATA 1 ) )}{\partial {V}_{DATA}} \qquad ( Equation 3 )$$

The operation circuit 309 may perform a differentiation using the difference between the second point P6003 to which the second data voltage (VDATA2) is applied and the second point′ P6003′ to which the second data voltage′ (VDATA2+ΔVDATA2) is applied. The second differential element (ΔP6003′), which is the result of performing the partial differentiation on the second point, may be expressed as Equation 4.

$$Δ P {6003}^{′} = \frac{\partial ( Iout 22 - Iout 21 )}{\partial {V}_{DATA}} = \frac{\partial ( f ( VDATA 2 + Δ VDATA 2 ) - f ( VDATA 2 ) )}{\partial {V}_{DATA}} \qquad ( Equation 4 )$$

Afterwards, the data driver 33 indefinitely integrates the first equation (e.g., Equation 2) with respect to the first data signal to obtain the second equation (e.g., Equation 5) (S1009).

For example, the operation circuit 309 may perform an indefinite integration on the differentiated first output current expressed in Equation 2 using the first data signal as a variable. The result of the indefinite integration performed by the operation circuit 309 may be expressed as Equation 5 below.

$$\int \frac{\partial {I}_{OUT}}{\partial {V}_{DATA}} {V}_{DATA} = \int \frac{\partial F ( {V}_{DATA} )}{\partial {V}_{DATA}} {V}_{DATA} = f ( {V}_{DATA} ) + C ( here , C is a constant ) \qquad ( Equation 5 )$$

The current value according to the result of the calculation in the operation circuit 309 may be a value that removes the influence of the leakage current from the output current Iout measured in the measurement circuit 307.

Referring to FIG. 12, the third graph 703 is a graph showing the result of performing a partial differentiation with the data signal as a variable for the first output current and then performing an indefinite integration. For example, the result of performing an indefinite integration on the first differential element (ΔP6001′) corresponding to the first point of FIG. 11A may be expressed as Equation 6 below.

$$\int \frac{\partial ( Iout 12 - Iout 11 )}{\partial {V}_{DATA}} \partial {V}_{DATA} = \int \frac{\partial ( f ( VDATA 1 + Δ VDATA 1 ) - f ( VDATA 1 ) )}{\partial {V}_{DATA}} \partial {V}_{DATA} \qquad ( Equation 6 )$$

Accordingly, the operation circuit 309 may obtain the relationship equation of the pixel current according to the data signal to be applied.

The data driver 33 estimates the first pixel current for the first data signal based on a second equation (e.g., Equation 5) (S1011).

The data driver 33 obtains the pixel characteristic data PXD indicating the characteristic of the selection pixel based on the first pixel current (S1013).

For example, the pixel characteristic data PXD may indicate the magnitude of the pixel current output from the selection pixel according to the magnitude of the data voltage applied to the selection pixel.

The data driver 33 may transmit the pixel characteristic data PXD to the timing controller 31. The timing controller 31 may control the data driver 33 to generate the data signal by compensating the image data based on the pixel characteristic data PXD.

The timing controller 31 may compensate for the magnitude of the applied data voltage so that the applied data voltage corresponds to a desired (and/or alternatively predetermined) ideal data based on the pixel characteristic data PXD.

For example, in the pixel characteristic data PXD corresponding to the first pixel, it is assumed that a pixel current of 0.3 A is output when a data voltage of 1V is applied. In the pixel characteristic data PXD corresponding to the second pixel, it is assumed that a pixel current of 0.3 A is output when a data voltage of 1.1V is applied. It is assumed that an ideal pixel outputs a pixel current of 0.31 A when a data voltage of 1V is applied, and outputs a pixel current of 0.3 A when a data voltage of 0.98V is applied. When an input image signal IS corresponding to the pixel current of 0.3 A is received, the timing controller 31 may compensate for 0.02V, which is the difference between the ideal data voltage of 0.98V and the actual data voltage of 1V based on the pixel characteristic data PXD corresponding to the first pixel. The timing controller 31 may compensate for 0.12V, which is the difference between the ideal data voltage of 0.98V and the actual data voltage of 1.1V based on the pixel characteristic data PXD corresponding to the second pixel. Accordingly, the timing controller 31 may control each of the plurality of pixels PX to output the more uniform current.

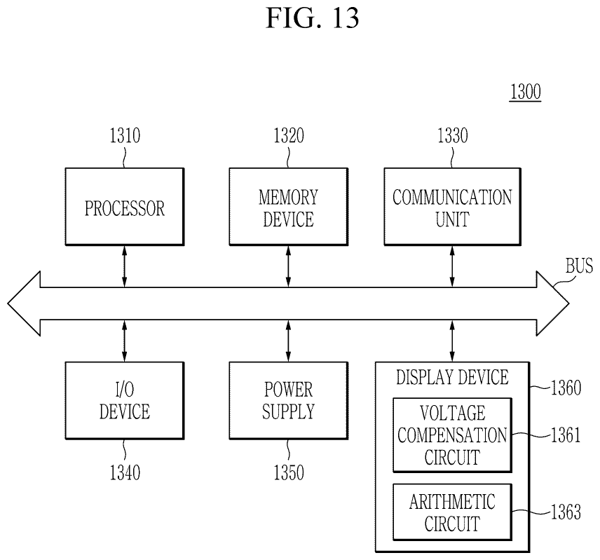

FIG. 13 is a block diagram showing an electron system according to some example embodiments.

Referring to FIG. 13, an electronic system 1300 may include a processor 1310, a memory device 1320, a communication unit 1330, an input/output device 1340, a power supply 1350, and a display device 1360. The electronic system 1300 may further include several ports that may communicate with video cards, sound cards, memory cards, USB devices, etc., or with other systems.

The processor 1310 may control the overall operation of the electronic system 1300 and may run operating systems, applications, etc.

The memory device 1320 may store a data necessary for the operation of the electronic system 1300.

The communication unit 1330 may communicate with external devices.

The input/output device 1340 may include input devices such as a keyboard, keypad, touchpad, touchscreen, mouse, remote controller, etc., and output devices such as a speaker, printer, etc.

The power supply 1350 may supply a power necessary for the operation of the electronic system 1300.

The display device 1360 may include a display panel and a display driver IC and may be a display device according to some example embodiments of the present disclosure. The display driver IC may be a display driver IC according to some example embodiments of the present disclosure.

In some example embodiments, the display device 1360 may include a voltage compensation circuit 1361 and an operation circuit 1363 for detecting the characteristic of the plurality of pixels.

The operation circuit 1363 may remove the influence of terms including the leakage current by performing the partial differentiation on the output current output from the plurality of pixels by using the data signal applied to the pixel as a variable, and perform the indefinite integration on the partial differentiated values by using the data signal as a variable. Accordingly, the operation circuit 1363 may obtain the pixel characteristic data about the pixel current output from the selection pixel according to the data signal applied to the selection pixel. Accordingly, the display device 1360 may obtain the information about the pixel current according to the data voltage applied to each of plurality of pixels without being affected by the leakage current occurring within the display panel.

The voltage compensation circuit 1361 may generate a compensation voltage based on the ideal data and the pixel characteristic data indicating the ideal co-relationship between the data voltage and the pixel current.

In some example embodiments, the voltage compensation circuit 1361 may generate a compensation voltage based on the difference between the voltage value of the ideal data corresponding to the image data and the voltage value of the pixel characteristic data corresponding to the image data.

The display device 1360 may be controlled to have the more uniform luminance throughout the display panel by compensating for the data signal applied based on the characteristics of each of the plurality of pixels, thus improving the quality of a displayed image.

One or more of the elements disclosed above may include or be implemented in processing circuitry such as hardware including logic circuits; a hardware/software combination such as a processor executing software; or a combination thereof. For example, the processing circuitry may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, an application-specific integrated circuit (ASIC), etc.

While this disclosure has been described in connection with what is presently considered to be some example embodiments, it is to be understood that the disclosure is not limited to the disclosed example embodiments, but, on the contrary, is intended to cover various modifications and equivalent arrangements included within the spirit and scope of the appended claims.

What is claimed is:

1. A display device comprising:
a display panel including a plurality of pixels connected to a plurality of data lines and a plurality of return lines;
a timing controller configured to generate first image data corresponding to a first selection pixel connected to a first data line among the plurality of data lines and a first return line among the plurality of return lines; and
a data driver configured to apply a first data signal corresponding to a measurement reference voltage to the first selection pixel through the first data line, measure a characteristic of the first selection pixel based on a first return signal received through the first return line, and generate a second data signal corresponding to the first image data based on the characteristic of the first selection pixel.

2. The display device of claim 1, wherein the data driver includes:
a driving circuit configured to generate the second data signal while the display panel displays an image based on the second data signal; and
a sensing circuit configured to receive the first return signal, and generate a pixel characteristic data including the characteristic of the first selection pixel based on the first return signal, while the display device performs a pixel characteristic measurement operation to measure the characteristic of the first selection pixel.

3. The display device of claim 2, wherein the driving circuit includes:
a digital analog converter configured to receive the first image data and generate a first gamma voltage corresponding to the first image data;
a voltage compensation circuit configured to generate a compensation voltage based on the first image data and the pixel characteristic data; and
an adder configured to generate the second data signal by adding the first gamma voltage and the compensation voltage.

4. The display device of claim 3, wherein
the voltage compensation circuit is configured to determine the compensation voltage based on a difference of a first voltage value corresponding to the first image data in the pixel characteristic data, and a second voltage value corresponding to the first image data in an ideal data for an ideal first pixel current output from the first selection pixel in response to applying the first data signal to the first selection pixel.

5. The display device of claim 2, wherein
in response to the display device performing the pixel characteristic measurement operation, the driving circuit is configured to receive a second image data corresponding to the measurement reference voltage, generate a second gamma voltage corresponding to the second image data, and generate the first data signal based on the second gamma voltage.

6. The display device of claim 5, wherein the sensing circuit includes:
a measurement circuit configured to measure the first return signal to generate a return signal data; and
an operation circuit configured to generate a first equation by performing a partial differentiation on the return signal data with the first data signal as a variable, generate a second equation by performing an indefinite integration on the first equation with the first data signal as a variable, and generate the pixel characteristic data based on the second equation.

7. The display device of claim 6, wherein
the pixel characteristic data indicates a value of a first pixel current output from the first selection pixel based on applying the first data signal to the first selection pixel.

8. The display device of claim 7, wherein
the first return signal is a sum of the first pixel current and a leakage current output from a non-selection pixel, the non-selection pixel being a pixel other than the first selection pixel from among the plurality of pixels connected to the first return line.

9. The display device of claim 2, wherein
the display device is configured to perform the pixel characteristic measurement operation during a vertical blank period during which the display panel does not display an image based on the second data signal.

10. An operation method of a display device comprising:
determining a first pixel among a plurality of pixels connected to a plurality of data lines and a plurality of return lines as a selection pixel;
applying a first data signal corresponding to a measurement reference voltage to the selection pixel through a first data line connected to the selection pixel among the plurality of data lines;
measuring a first output current received through a first return line connected to the selection pixel among the plurality of return lines;
obtaining a first equation by performing a partial differentiation on the first output current with respect to the first data signal;
obtaining a second equation by performing an indefinite integration on the first equation with respect to the first data signal;
measuring a first pixel current output from the selection pixel in response to the first data signal being applied to the selection pixel based on the second equation; and
obtaining a pixel characteristic data indicating a characteristic of the selection pixel based on the first pixel current.

11. The operation method of the display device of claim 10, wherein measuring the first output current includes:
measuring the first output current based on applying a first data voltage of the first data signal to the selection pixel;
measuring another first output current based on applying another first data voltage different than the first data voltage to the selection pixel; and
obtaining a return signal data for a first return signal based on the first output current and the another first output current.

12. The operation method of the display device of claim 11, wherein
the return signal data is
$$IOUT = f ( {V}_{DATA} ) + f ( w ) ,$$
Iout is the first output current, Vdata is the first data signal, and w is an arbitrary constant,
the first equation is
$$\frac{\partial {I}_{OUT}}{\partial {V}_{DATA}} = \frac{\partial f ( {V}_{DATA} )}{\partial {V}_{DATA}} + \frac{\partial f ( w )}{\partial {V}_{DATA}} = \frac{\partial f ( {V}_{DATA} )}{\partial {V}_{DATA}} ,$$
the second equation is
$$\int \frac{\partial {I}_{OUT}}{\partial {V}_{DATA}} {V}_{DATA} = \int \frac{\partial F ( {V}_{DATA} )}{\partial {V}_{DATA}} {V}_{DATA} = f ( {V}_{DATA} ) + C ,$$
C is a constant.

13. The operation method of the display device of claim 10, further comprising:
receiving a first input image signal;
converting the first input image signal into a first image data;
generating a first gamma voltage corresponding to the first image data;
determining a compensation voltage based on the pixel characteristic data,
generating a second data signal by adding the first gamma voltage; and
applying the second data signal to the selection pixel corresponding to the first input image signal.

14. The operation method of the display device of claim 13, wherein
in the display device, in response to applying the first data signal to the selection pixel, an ideal data for an ideal first pixel current output from the selection pixel is predetermined, and
said determining the compensation voltage includes determining the compensation voltage based on a difference of a first voltage value corresponding to the first image data in the pixel characteristic data and a second voltage value corresponding to the first image data in the ideal data.

15. A display device comprising:
a display panel including a plurality of pixels connected to a plurality of data lines and a plurality of return lines;
a timing controller configured to generate first image data, store a pixel characteristic data indicative of a value of a first pixel current output from a first selection pixel among the plurality of pixels in response to a first data signal applied to the first selection pixel, and store an ideal data indicating an ideal co-relationship between the first data signal and the first pixel current; and
a data driver configured to generate a first gamma voltage corresponding to the first image data, determine a compensation voltage based on the ideal data and the pixel characteristic data, and generate a second data signal corresponding to the first image data by adding the first gamma voltage and the compensation voltage.

16. The display device of claim 15, wherein
the data driver is configured to apply another second data signal corresponding to a measurement reference voltage to the first selection pixel through a first data line connected to the first selection pixel among the plurality of data lines, and measure a characteristic of the first selection pixel based on a first return signal received through a first return line among the plurality of return lines connected to the first selection pixel.

17. The display device of claim 16, wherein
the data driver is configured to measure the first return signal to generate a return signal data, and
the data driver further comprises an operation circuit configured to perform a partial differentiation with the first data signal as a variable for the return signal data to generate a first equation and perform an indefinite integration with the first data signal as a variable for the first equation to generate a second equation.

18. The display device of claim 17, wherein
the return signal data is determined based on a first output current obtained based on applying a first data voltage of the second data signal to the first selection pixel and another first output current obtained based on applying another first data voltage different than the first data voltage to the first selection pixel.

19. The display device of claim 18, wherein
the return signal data is
$$IOUT = f ( {V}_{DATA} ) + f ( w ) ,$$
Iout is the first output current, Vdata is a first data signal, and w is an arbitrary constant,
the first equation is
$$\frac{\partial {I}_{OUT}}{\partial {V}_{DATA}} = \frac{\partial f ( {V}_{DATA} )}{\partial {V}_{DATA}} + \frac{\partial f ( w )}{\partial {V}_{DATA}} = \frac{\partial f ( {V}_{DATA} )}{\partial {V}_{DATA}}$$
the second equation is
$$\int \frac{\partial {I}_{OUT}}{\partial {V}_{DATA}} {V}_{DATA} = \int \frac{\partial F ( {V}_{DATA} )}{\partial {V}_{DATA}} {V}_{DATA} = f ( {V}_{DATA} ) + C ,$$
C is a constant.

20. The display device of claim 15, wherein
the compensation voltage is determined based on the pixel characteristic data and an ideal data for a magnitude of a second pixel current output from a second pixel in response to applying a data voltage to the second pixel among the plurality of pixels.
